(19) United States
(12) Patent Application Publication
(10) Pub. No.: US 2006/0022478 A1
(43) Pub. Date: Feb. 2, 2006

(54) REMOVABLE MULTIPURPOSE CONSOLE

(76) Inventors: Aaron DeLong, Oxford, MI (US); Frank L. Violet, Troy, MI (US); Gerald Krause, Utica, MI (US); John Applin, Fenton, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/710,711

(22) Filed: Jul. 29, 2004

(51) Int. Cl. B60N 3/12

(52) U.S. Cl. 296/37.8

(57) ABSTRACT

The present invention provides for an improved multipurpose console, such as a center floor console, that integrates a number of desirable features into a removable and easily portable structure to provide greater comfort and convenience to vehicle occupants. In one embodiment, the multipurpose console includes a housing having a latching mechanism fixedly configured to releasably engage a mounting member of the vehicle and an anchor point associated with the housing so that a transport device may be removably secured thereto to transport the removable console to any desired location. The housing may further be provided with laptop anchor points adapted to securely receive a laptop computer and/or power and sound contacts respectively adapted to cooperate with power and sound sources of the vehicle to provide power and sound to the console.

### FIELD OF THE INVENTION

The present invention pertains generally to consoles for automotive interiors and, more particularly, to a removable multipurpose console for automotive interiors.

### BACKGROUND OF THE INVENTION

It is known to provide automotive interiors with various trim assemblies to improve the comfort and convenience of vehicle occupants and for the aesthetic appearance of the automotive interior. Examples of these interior trim assemblies include the instrument panels, armrests, door panels, and consoles. In certain trim assemblies, such as for some floor consoles, it is desirable to incorporate a compartment therein to allow the vehicle occupant to conveniently store items, e.g. coins, maps, CDs, and the like, typically carried in a vehicle. In many cases, the compartment includes a door or cover that overlies the opening and secures the items within the compartment. In addition, some consoles are provided with multiple storage compartments, as well as separate pen and pencil holders, tissue holders, CD/DVD storage holders, and the like.

Other floor consoles include cooler compartments adapted to provide cold or warm storage for food and/or drink items, and entertainment devices, such as DVD players. These devices may be provided in conjunction with one or more storage compartments. By integrating various amenities into the multipurpose console, space can be saved within the vehicle. Also, separate transportation of various items, which have been incorporated into the multipurpose console, is no longer necessary. Some of these consoles further are adapted to be removable from the interior of the vehicle so that the owner or vehicle occupant can transport the console to a preferred location. Battery sources, i.e. rechargeable or disposable batteries, are provided to power the cooler compartments and entertainment devices of these consoles.

While removable multipurpose consoles can be desirable by car owners and vehicle occupants, current consoles have some drawbacks. One drawback involves a lack of desired additional features or amenities to improve console functionality, and for greater comfort and convenience of vehicle owners and occupants.

For example, as consumers become more technologically savvy and reliant on portable laptop computers, one additional desirable amenity includes laptop anchor points that cooperate and are adapted to securely receive a laptop computer. Another desirable amenity involves console power contacts, adapted to utilize the power source of the vehicle, so that a console user can avoid draining the power from rechargeable or disposable battery sources. The power contacts may be further utilized to recharge the rechargeable battery source, as well as provide power to an optional and desirable 110 volt power outlet. It is also especially desirable for the removable multipurpose console to be easily transported to any preferred location so that an occupant may utilize the features thereof outside of the vehicle. Accordingly, other additional desired features may be incorporated that appear to be lacking in today's removable multipurpose consoles.

There is thus a need for an improved multipurpose console that integrates a number of desirable features into a removable and easily portable structure.

### SUMMARY OF INVENTION

The present invention provides for an improved multipurpose console, such as a center floor console, having a variety of components incorporated therein. The console is adapted to be removably secured within a motor vehicle, such as between the driver and front passenger seats, and is adapted for easy transport therefrom to any desired location for use outside of the vehicle.

To this end, one exemplary embodiment of the multipurpose console includes a housing having a latching mechanism fixedly secured to a lower surface of the housing. This latching mechanism is configured to releasably engage a mounting mechanism of the vehicle so that the multipurpose console may be fastened thereto and removed therefrom. Also, a transport device, such as a shoulder strap, may be removably secured to the housing to transport the removable console to any desired location. Specifically, one or more anchor points are associated with the housing for attaching the transport device thereto. The housing further may include one or more laptop anchor points adapted to securely receive a laptop computer and advantageously are moveably attached to the console for movement between an open position, wherein the laptop computer may be secured thereto, and a closed position, wherein the laptop anchor points are retained within the housing.

In another exemplary embodiment, the housing is provided with the releasably engaging latching mechanism and the transport device for easy portability of the console, and further includes power and sound contacts. The power contact is adapted to cooperate with a power source of the vehicle to provide power to the console to allow a user to operate one or more incorporated devices such as a radio, DVD player, MP3 input, and/or navigational unit, as well as a thermoelectric device for heating and/or cooling of food or drink items. The power contact further may be adapted to recharge a battery source provided within the console and/or adapted to provide power to an optional 110 volt power outlet incorporated into the console. The sound contact is adapted to cooperate with the vehicle to provide sound to the console from the vehicle's audio components, e.g. a radio, or to provide sound to the vehicle's speakers from the console's electronic devices, e.g. a radio, DVD player, etc.

Accordingly, the incorporation of additional features, in conjunction with the removability and portability of the console, add desired functionality and provide greater convenience and comfort for the vehicle owner and/or occupant.

By virtue of the foregoing, there is thus provided an improved multipurpose console that integrates a number of desirable components into a removable and easily portable structure.

The features and objectives of the present invention will become more readily apparent from the following Detailed Description taken in conjunction with the accompanying drawings.

### BRIEF DESCRIPTION OF DRAWINGS

The accompanying drawings, which are incorporated in and constitute a part of this specification, illustrate embodiments of the invention and, together with a general description of the invention given above, and the detailed description given below, serve to explain the invention.

FIG. 1 is a view of the interior of an automobile including an embodiment of the multipurpose console of the present invention;

FIG. 1A is an enlarged view of a cut-away portion of the multipurpose console of FIG. 1;

FIG. 2 is a side perspective view of the multipurpose console of FIG. 1;

FIG. 3 is a side perspective view of the multipurpose console of FIG. 1 illustrating the laptop anchor points and laptop platform;

FIG. 3A is an enlarged side perspective view of the laptop anchor point of FIG. 3;

FIG. 4A is the first in a series of sequential side perspective views of the multipurpose console of FIG. 1 illustrating the fastening of a laptop computer to the console;

FIG. 4B is the second in this series of side perspective views;

FIG. 4C is a perspective view of an embodiment of the laptop platform of the present invention;

FIG. 5A is a bottom plan view of the multipurpose console of FIG. 1;

FIG. 5B is the first in a series of side elevational views showing a cross-sectioned bottom area of the multipurpose console of FIG. 1 illustrating the fastening to and release from a vehicle; FIG. 5C is the second in this series of side elevational views;

FIG. 6 is a cross-sectional view of FIG. 5A taken along lines 6-6; and

FIG. 7 is a side perspective view of the multipurpose console of FIG. 1 illustrating the anchor points and transport device.

### DETAILED DESCRIPTION

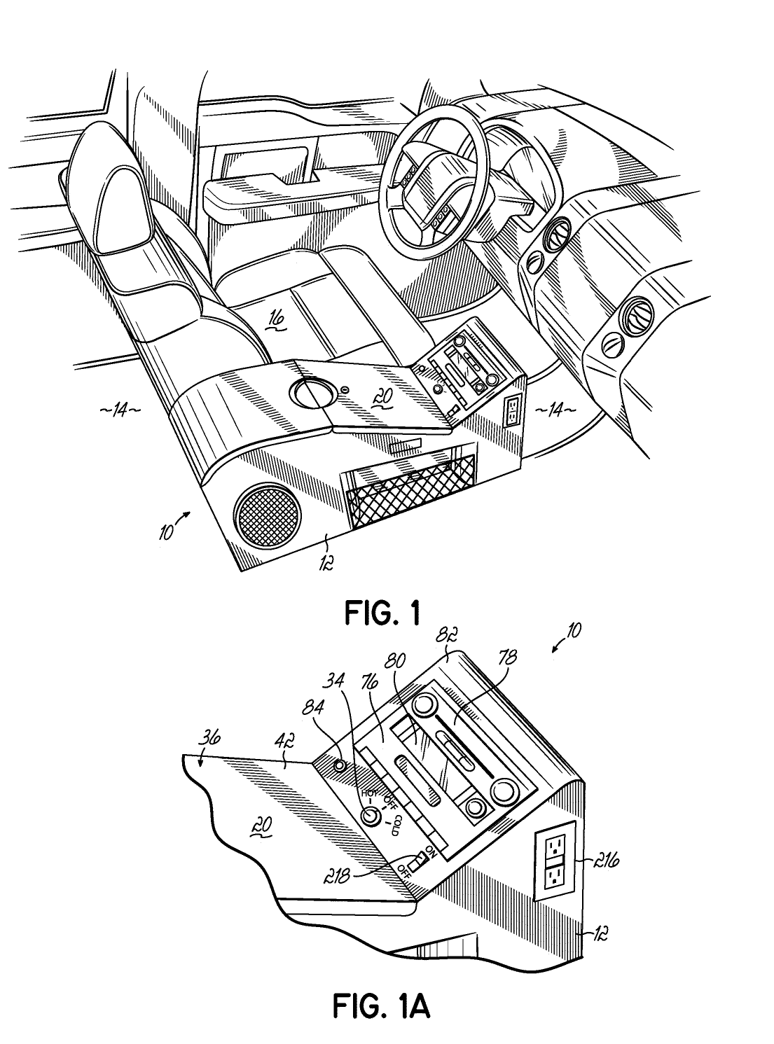

In FIG. 1, there is shown an exemplary embodiment of the removable multipurpose console 10. The multipurpose console 10 includes a housing 12 constructed of a durable, lightweight, easily-molded material such as plastic and generally has a rectangular configuration. It should be understood that the console 10 may be constructed out of other materials and come in a variety of shapes and sizes. Although the console 10 of the present invention may be removably provided in a variety of locations within a vehicle's interior 14, the console 10 advantageously is adapted for use as a center floor console 10 positioned intermediate the driver's seat 16 and front passenger's seat (not shown) or intermediate the back passenger seats (not shown). The top surface 20 of the console 10 further is configured to provide an armrest for the vehicle occupants.

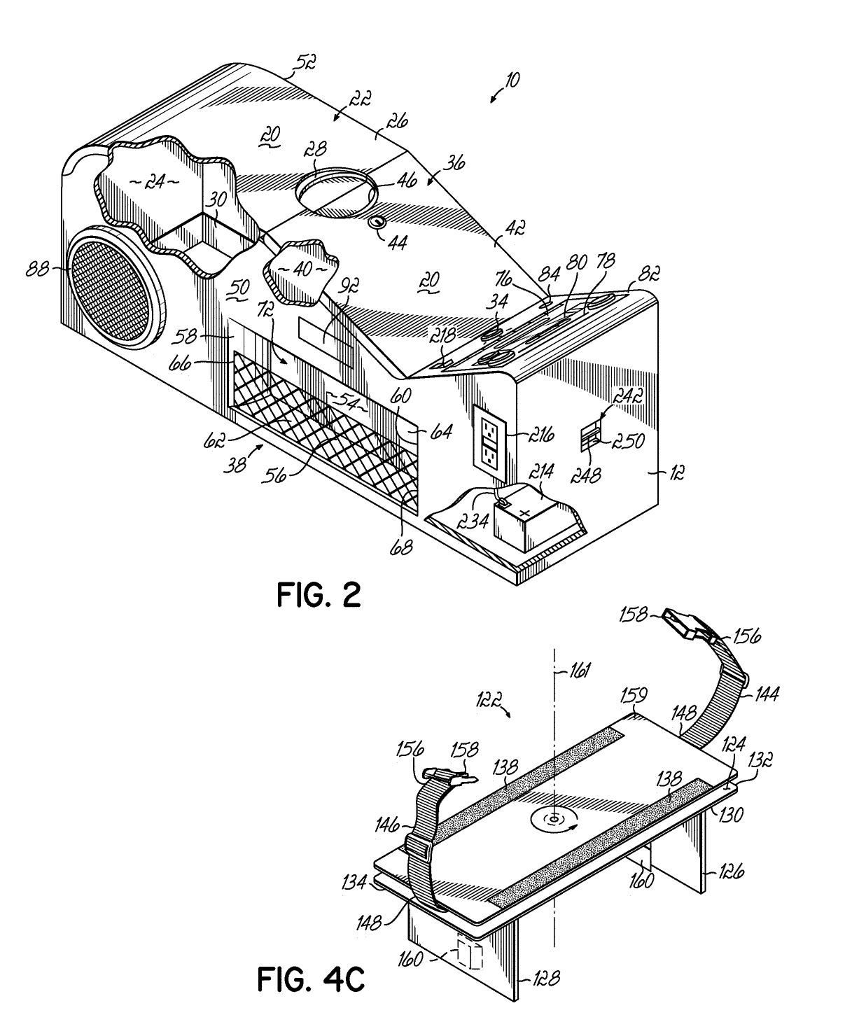

As best shown in FIG. 2, the housing 12 of the console 10 includes a cooler compartment 22 situated in the top surface 20 thereof and defines a cavity 24 adapted for storing food and/or drink items (not shown) therein. The cooler compartment 22 further is provided with a lid 26 pivotally coupled to the top surface 20 of the housing 12, such as via a living hinge or other hinge means commonly known in the art, and is moveable between an open position, wherein the cavity 24 may be accessed, and a closed position, wherein the lid 26 covers the cavity 24. The lid 26 also is provided with a handle 28 for easy opening thereof. A thermoelectric device 30, such as a thermoelectric module or chip commonly known in the art, further is provided within the housing 12 and is associated with the cooler compartment 22 for heating or cooling the food and/or drink items within the cooler compartment 22. The thermoelectric module 30 is activated by a selector switch 34 located on the top surface 20 of the console 10. As best shown in FIG. 1A, the selector switch 34 is positionable from an off position to either a heating or cooling position.

As further shown in FIG. 2, the housing 12 further includes first and second storage compartments 36 and 38. The first storage compartment 36 is situated within the top surface 20 of the housing 12 and defines a cavity 40 adapted for storing one or more items (not shown) such as coins, maps, CDs, etc. A lid 42 further is pivotally coupled to the top surface 20 of the housing 12, such as via a living hinge or other hinge means commonly known in the art, and is moveable between an open position, wherein the cavity 40 may be accessed, and a closed position, wherein the lid 42 covers the cavity 40. The lid 42 is provided with a lock 44 for securing the lid 42 to the housing 12 and a handle 46 for easy opening thereof. The multipurpose console 10, as earlier indicated, may further function as an armrest. Notably, an arm (not shown) of a vehicle occupant may be rested on the lids 26, 42 of the cooler and/or first storage compartment 22, 36 when the lids 26, 42 are in a closed position.

The second storage compartment 38 is provided on one of two opposing sides 50 and 52 of the housing 12 and generally is defined by a recessed area 54 contained therein and a net 56, such as a cargo net, stretched along the length of the recessed area 54. Notably, the recessed area 54 includes opposing side walls 58 and 60, bottom wall 62, and a back wall 64 with opposing ends 66 and 68 of the net 56 being secured to the side walls 58, 60 whereby a top opening 72 is provided which permits access to the compartment 38. Accordingly, the net 56 is adapted to retain items (not shown), such as CDs, DVDs, headphones, apparel, etc., placed within the second compartment 38.

As best shown in FIG. 1A, the housing 12 further includes one or more optional electronic devices. More specifically, a combination FM/AM radio 76 with CD/DVD player 78 and viewing screen 80 is incorporated into a sloped portion 82 of the top surface 20 of the housing 12. Accordingly, the viewing screen 80 may be utilized to view selected radio channels, CD track numbers and song titles, as well as DVDs, etc. A navigational unit (not shown) and MP3 input 84 further are provided in the sloped portion 82 of the top surface 20. The viewing screen 80 may be further adapted so that a user can view information and data relayed from the MP3 input 84 and/or navigational unit. It should be understood that one or more separate viewing screens 80 may be incorporated into the console 10 to view DVDs, and/or MP3 or navigational information. Accordingly, the sloped portion 82 of the top surface 20 permits a user to easily and safely use these optional electronic devices, as well as conveniently view the viewing screen 80. At least one speaker 88 (FIG. 2), advantageously a waterproof speaker, is secured within one side 50 (FIG. 2) of the housing and is associated with the applicable electronic devices such as the radio 76, CD/DVD player 78, and MP3 input 84 for emitting or outputting sound. Advantageously, more than one speaker 88 is provided in the housing 12 to provide for a quality sound.

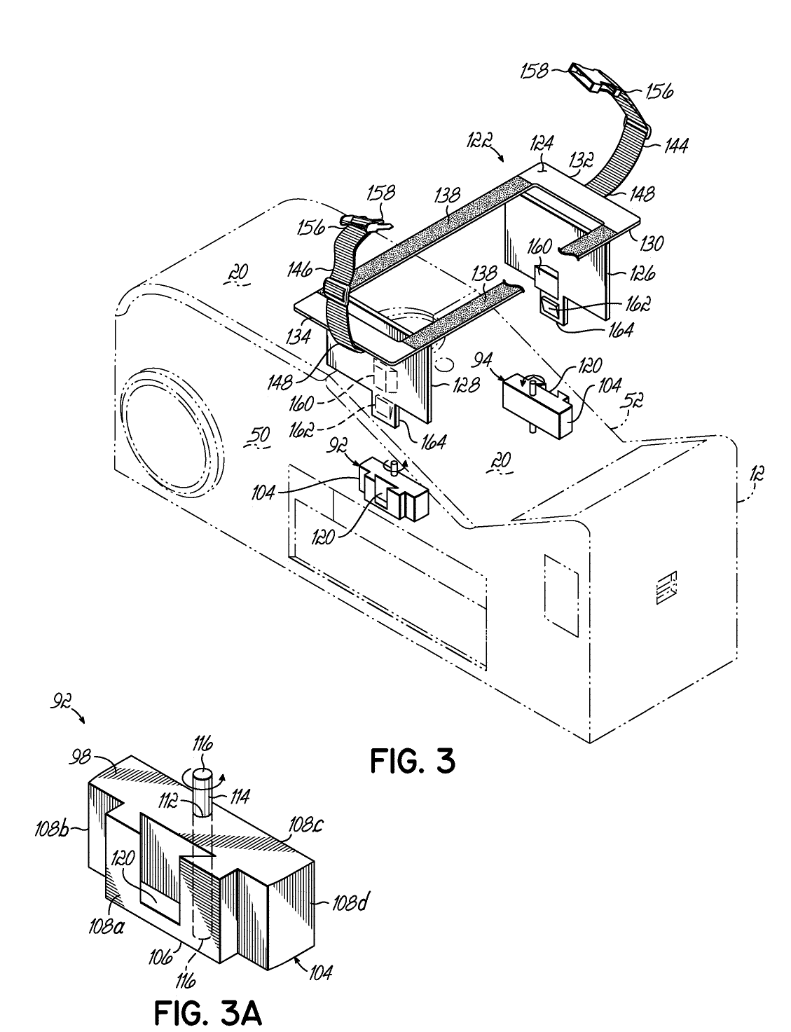

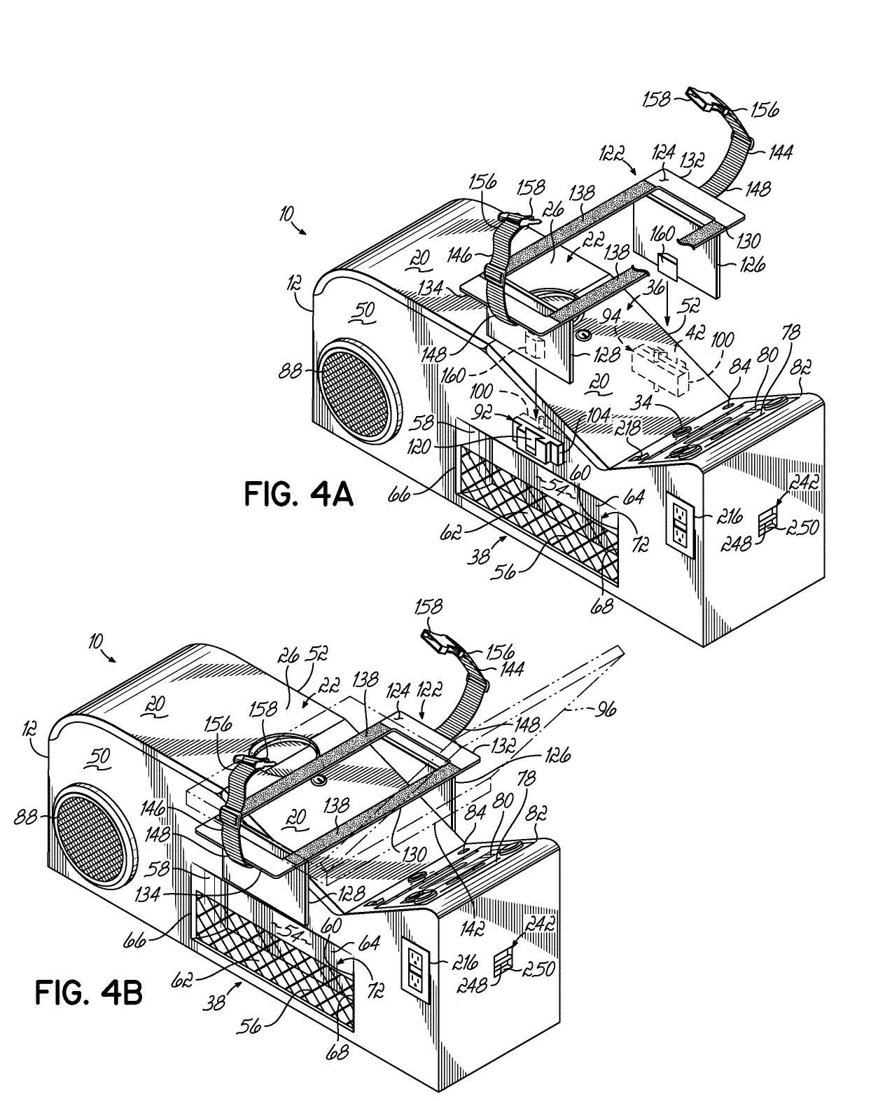

As shown in FIGS. 3, 3A, and 4A-4B, the housing 12 further includes two laptop anchor points 92 and 94 that are adapted to securely receive a laptop computer 96. Each laptop anchor point 92, 94 is oppositely located on opposing sides 50, 52 of the console 10 and, advantageously, is moveably secured within the housing 12 for movement between an open position, wherein the laptop anchor points 92, 94 extend outwardly therefrom to securely receive a laptop computer 96 on a top surface 98 thereof, and a closed position, wherein the laptop anchor points 92, 94 are retained within a recess 100 of the housing 12. Accordingly, each laptop anchor point 92, 94 includes a body 104 having opposing top and bottom surfaces 98 and 106 and generally four sidewalls 108a-d with one sidewall 108a defining an outer wall when the laptop anchor points 92, 94 are in an open position. An aperture 112 is provided through the body 104 extending from the top to the bottom surface 98, 106 to receive a vertically oriented hinge pin 114 secured by its ends 116 within the housing 12 to allow for pivotal movement of each laptop anchor point 92, 94. It is understood that the laptop anchor points 92, 94 further may be fixedly secured to sides 50, 52 of the housing 12 or movably secured therein in any number of ways. For example, the laptop anchor points 92, 94 may be slidably moved via spring means (not shown), commonly known in the art, between the open and closed position.

Notably, each laptop anchor point 92, 94 includes a cutout area 120 provided within a portion of both the outer wall 108a and top surface 98 to receive a laptop platform 122 adapted to retain the laptop computer 96 thereto. Specifically, the laptop platform 122 includes a top surface 124 provided with a means for retaining the laptop computer 96 and opposing first and second legs 126 and 128 extending away from a bottom surface 130 thereof adjacent opposing ends 132 and 134 of the platform 122. The retaining means include one or more Velcro strips 138 secured to the top surface 124 of the platform 122 for cooperating with corresponding Velcro strips (not shown) attached to a bottom surface 142 of the laptop computer 96. In addition, the retaining means also include first and second strap members 144 and 146 attached at one end 148 to each of the opposing ends 132, 134 of the platform 122 with the other ends 156 of the strap members 144, 146 adapted to mate, via clasp means 158, to further secure the laptop computer 96 to the platform 122. It should be understood that any number of retaining means including cables, ropes, buckles, snaps, clips, combinations thereof, and the like may be utilized to retain the laptop computer 96 to the platform 122.

As shown in FIG. 4C, the top surface 124 of the laptop platform 122 further may be modified so that a base 159 can be pivotally secured thereto, such as via a pivot pin and bearing means commonly known in the art, for rotating the laptop computer 96 about a vertical axis 161. The base 159 is provided with the means for retaining, i.e. the Velcro 138 and/or first and second strap members 144, 146, in order to retain the computer 96 thereon.

Referring again to FIGS. 3, 3A, and 4A-4B, each of the first and second legs 126, 128 include a male portion 160 protruding inwardly therefrom with each adapted to be securely received within the corresponding cutout area 120 of each of the laptop anchor points 92, 94. Accordingly, the top surface 98 of each laptop anchor point 92, 94 securely receives the laptop computer 96 that is retained on the laptop platform 122. It should be understood that the cutout areas 120 and corresponding male portions 160, although shown generally shaped as dovetails, may include any desired cooperating configuration and that the cutout areas 120 further may be provided completely within the top surfaces 98 of the laptop anchor points 92, 94.

FIG. 3 shows an optional protrusion 162 that may be provided on a distal end 164 of each leg 126, 128 wherein the protrusion 162 extends inwardly therefrom and is spaced apart from the male portion 160. Each protrusion 162 is adapted to cooperate with the bottom surface 106 of the body 104 of the laptop anchor point 92, 94 such that the optional protrusions 162, in cooperation with the male portions 160, further securely retain the laptop platform 122 to the laptop anchor points 92, 94. It should be further understood that only one laptop anchor point 92, 94 may be provided for cooperating with one male portion 160 to receive the laptop platform 122. In addition, the male portion 160 may extend away from one leg 126, 128 so that the laptop platform 122 extends in a direction away from the console 10 when received by the anchor point 92, 94.

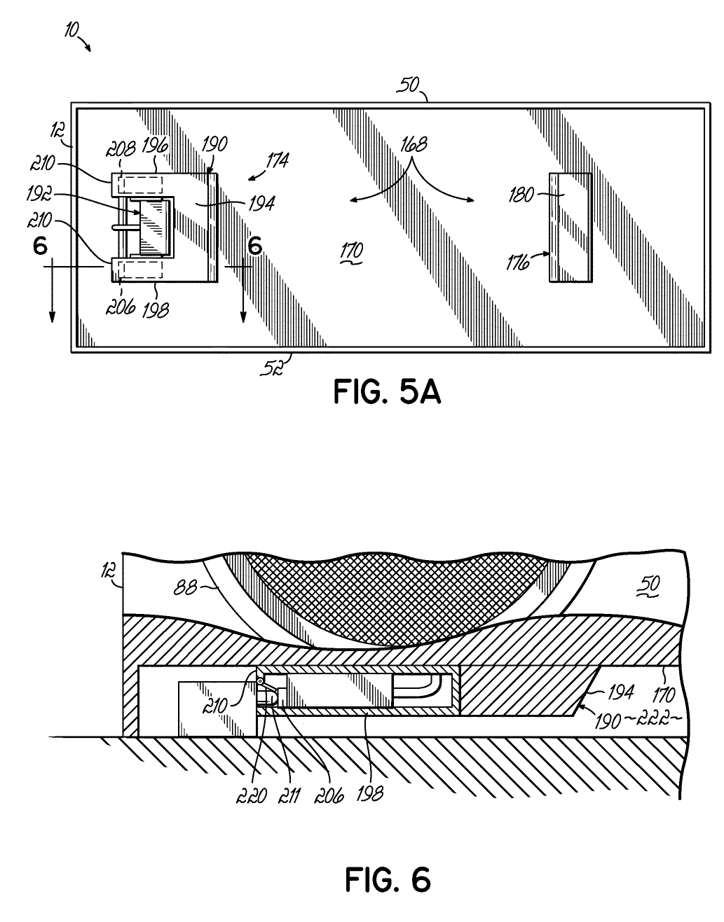

As further shown in FIGS. 5A-5C, the housing 12 further includes a latching mechanism 168 fixedly secured to a lower surface 170 of the housing 12 and configured to releasably engage a mounting mechanism 172 of the vehicle so that the multipurpose console 10 may be fastened thereto and removed therefrom. Specifically, the latching mechanism 168 includes a back latch assembly 174 and a front hook 176. The front hook 176 includes an L-shaped body portion 180 that defines a recessed area 182 having an opening 184 that faces away from the back latch assembly 174. The recessed area 182 of the front hook 176 is adapted to engage a first mounting member 186 of the mounting mechanism 172. The back latch assembly 174 includes first and second members 190 and 192 with the first member 190 including a body portion 194 having opposing legs 196 and 198 extending therefrom in a direction away from the front hook 176 to define a substantially U-shaped first member 190. The second member 192 is located substantially intermediate the legs 196, 198 and defines a spring-biased anchor latch for releasably fastening the anchor latch 192 to a second mounting member 202 of the mounting mechanism 172 which includes a pin member 204.

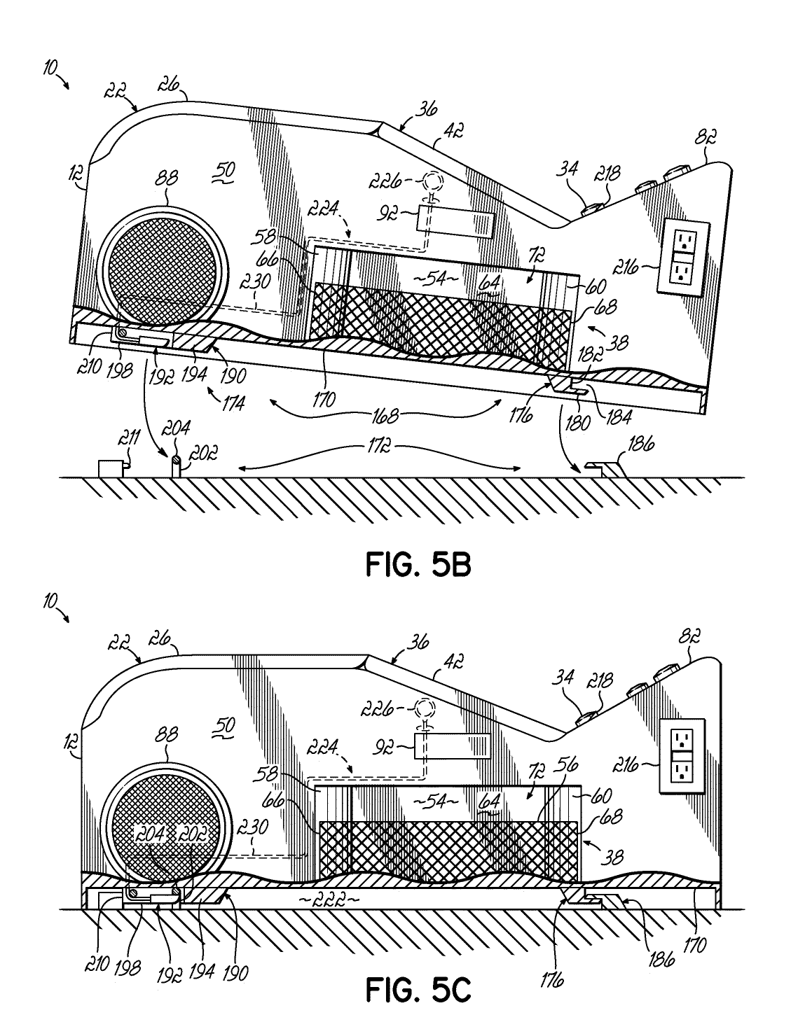

As best shown in FIGS. 5A and 6, recessed power and sound contacts 206 and 208 further are provided within distal ends 210 of the legs 196, 198 of the body portion 194 of the first member 190 of the back latch assembly 174. The power contact 206 is adapted to cooperate with a power source (not shown) of the vehicle, i.e. receive a male counterpart power contact 211, as is commonly known in the art, to complete a circuit and provide power from the vehicle, such as from the car battery, directly to the electronic devices, e.g. thermoelectric device 30 (FIG. 2), radio 76 (FIG. 2), etc., of the console 10 when the console 10 is fastened to the vehicle and the vehicle is turned on. The power contact 206 further is adapted to recharge a rechargeable battery source 214 (FIG. 2) and to provide the proper voltage, such as via the vehicle's alternator, to a 110 volt outlet 216 (FIG. 2) when the console 10 is fastened to the vehicle and the vehicle is turned on. An optional power switch 218 (FIG. 1A) may be provided to allow the user to toggle between using the console battery power 214 or vehicle power when the console 10 is secured to the vehicle.

The sound contact 208 is adapted to cooperate with a sound source of the vehicle, i.e. receive a male counterpart sound contact (not shown), as is commonly known in the art, to complete a circuit and provide sound from the vehicle's audio components (not shown), e.g. radio, CD/DVD player, etc., to the housing speaker 88 (FIG. 2) when the console 10 is fastened to the vehicle. In the alternative, sound also may be provided from the console 10 to a vehicle's speakers when the console's electronic devices are utilized. When the console 10 is not secured to the vehicle, the power and sound contacts 206, 208 may be covered by covers 220, such as spring loaded covers, to protect the contacts 206, 208.

Referring to FIGS. 5B, 5C, and 6, to secure the console 10 to the vehicle, the front hook 176 first is coupled to the first mounting member 186 generally by receiving within the recessed area 182 a portion of the first mounting member 186. The anchor latch 192 of the back latch assembly 174 then is spring biased against a horizontally positioned pin member 204 of the second mounting member 202 by pressing the first and second members 190, 192 into a receiving area 222, which further includes counterpart male power contact 211 and sound contact (not shown). As a result, the first and second members 190, 192 are received within the receiving area 222 and the power and sound contacts 206, 208 of the legs 196, 198 cooperate with the corresponding vehicle power contact 211 and sound contact (not shown). Notably, the console 10 is securely fastened to the vehicle and prevented from moving in a side-to-side or front-to-back manner.

As best shown in FIGS. 5B and 5C, the console 10 can be quickly released from the mounting members 186, 202 by a release device 224 that includes a handle 226, located within the first compartment 36, and a cable 230 cooperating with the handle 226 and second member 192. The handle 226 is activated, i.e. pulled, so that the cable 230 pulls up on the second member 192 to release the second member 192 from the pin member 204. Then, the front hook 176 may be slidably removed from the first mounting member 186 so that console 10 may be transported from the vehicle. It should be understood that any number of latching mechanisms 168 may be employed to provide releasable attachment to a mounting mechanism 172 of the vehicle.

Referring again to FIG. 2, the rechargeable battery source 214, such as a 12 volt battery, and an associated inverter 234 further are incorporated within the housing 12 for providing battery power to the electronic devices including the thermoelectric device 30. Accordingly, the inverter 234 converts the battery's direct current into alternating current to the applicable electronic devices. As indicated above, the rechargeable battery source 214 further is adapted to receive a recharging voltage from the vehicle's electrical system, via the power contact 206 (FIG. 5A). Alternatively, the battery source 214 may be a disposable power supply, e.g. disposable batteries.

The 110 volt power outlet 216 is provided within one side 50 of the housing 12 and is adapted to receive a plug (not shown) and provide power to an independent electronic device (not shown) such as a DVD/CD player, handheld devices, TV, etc. The 110 volt power outlet 216 cooperates with the power contact 206 (FIG. 5A) of the console 10 to provide the necessary voltage via a vehicle's alternator by methods commonly known in the art.

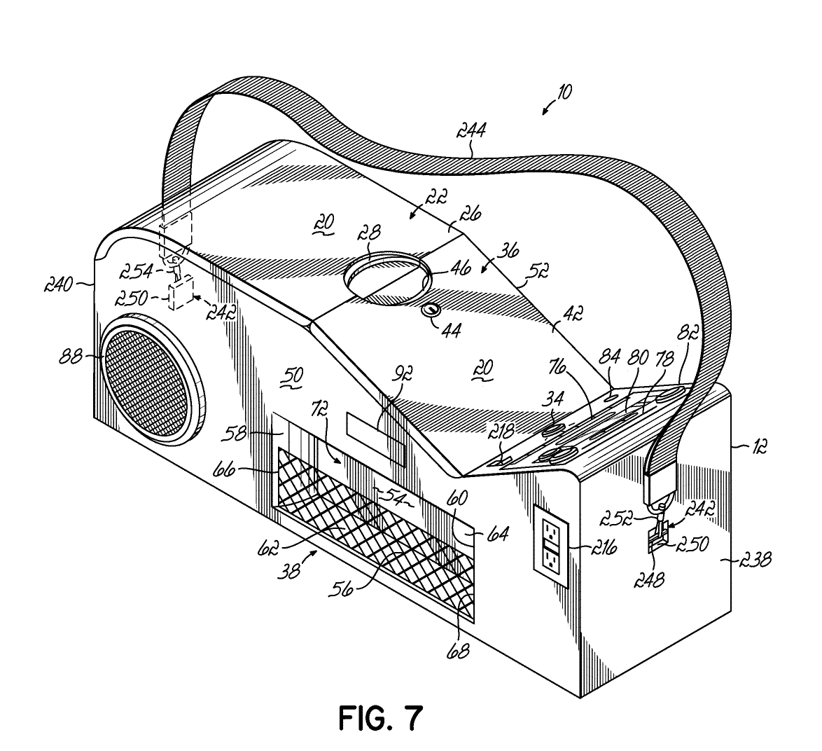

As best shown in FIG. 7, the housing 12 is further shown including opposing ends 238 and 240 with each end 238, 240 including an anchor point 242 adapted to releasably and securely receive a transport device 244, i.e. a shoulder strap. More specifically, each anchor point 242 includes a bar 248 extending longitudinally across a recessed area 250 within the housing 12. The transport device 244 includes opposing ends 252 and 254 defining clips wherein each of the opposing ends 252, 254 of the transport device 244 is removably secured to one of the two anchor points 242 to transport the removable console 10 to any desired location when not secured to the vehicle. While the transport device 244 is shown as being a shoulder strap, the transport device 244 may include any desired transport device 244 adapted to cooperate with one or more of the anchor points 242. In addition, it should be understood that one anchor point 242 may be provided for receiving the transport device 244 to transport the removable console 10.

Although the various amenities have been shown and described as being located on and within certain surfaces of the housing 12 of the console 10, it is understood that they may be incorporated into any number of locations or positions.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. a multipurpose console for use in a vehicle, comprising:
a housing comprising:
at least one laptop anchor point including a top surface adapted to securely receive a laptop computer, the laptop anchor point being moveably attached to the console for movement between an open position, wherein the laptop computer may be secured thereto, and a closed position, wherein the laptop anchor point is retained within the housing;
a latching mechanism, the latching mechanism being fixedly secured to a lower surface of the housing and configured to releasably engage a mounting mechanism of the vehicle so that the multipurpose console may be fastened thereto and removed therefrom; and
a transport device adapted to transport the removable console.

2. The multipurpose console of claim 1 wherein the console further includes a laptop platform adapted to retain the laptop computer and further is adapted to cooperate with the top surface of the at least one laptop anchor point to securely receive the laptop platform.

3. The multipurpose console of claim 1 wherein the at least one laptop anchor point comprises two laptop anchor points with each including top surfaces adapted to securely receive the laptop computer, each one of the two laptop anchor points being moveably attached to opposing sides of the console for movement between the open position, wherein the laptop computer may be secured thereto, and the closed position, wherein each laptop anchor point is retained within the housing.

4. The multipurpose console of claim 3 wherein the console further includes a laptop platform adapted to retain the laptop computer and further is adapted to cooperate with each top surface of the two laptop anchor points to securely receive the laptop platform.

5. The multipurpose console of claim 4 wherein each of the two laptop anchor points includes a body having a cutout area provided within at least a portion of the top surface, and wherein the platform includes spaced apart first and second legs extending in a direction away from the platform, the first and second legs being provided with a male portion extending therefrom with each male portion adapted to be securely received within one of the cutout areas of each of the two laptop anchor points to securely receive the laptop platform.

6. The multipurpose console of claim 5 wherein each of the first and second legs further include a protrusion provided on a distal end of each leg, each protrusion extending inwardly therefrom and spaced apart from the male portion, and further adapted to cooperate with the bottom surface of the body of the laptop anchor point to securely retain, in conjunction with the male portions, the laptop platform to the laptop anchor points.

7. The multipurpose console of claim 1 wherein the at least one laptop anchor point is fixedly secured to the housing in the open position.

8. A multipurpose console for use in a vehicle, comprising:
a housing comprising:
a power contact adapted to cooperate with a power source of the vehicle to provide power to the console;
a latching mechanism, the latching mechanism being fixedly secured to a lower surface of the housing and configured to releasably engage a mounting mechanism of the vehicle so that the multipurpose console may be fastened thereto and removed therefrom; and
a transport device adapted to transport the removable console.

9. The multipurpose console of claim 8 wherein the housing further includes a sound contact adapted to cooperate with the vehicle to provide sound to a speaker associated with the console.

10. The multipurpose console of claim 9 wherein the latching mechanism includes at least one of the power and sound contacts, the power and sound contacts adapted to cooperate with mating power and sound contacts of the vehicle when the latching mechanism is fastened to the mounting member of the vehicle.

11. The multipurpose console of claim 8 wherein the housing further includes at least one anchor point associated therewith, the transport device being removably secured to the at least one anchor point to transport the removable console.

12. The multipurpose console of claim 11 wherein the housing further includes opposing ends and the at least one anchor point comprises two anchor points, each of the two anchor points associated with one end of the housing, the transport device further including opposing ends, each of the opposing ends of the transport device being removably secured to one of the two anchor points to transport the removable console.

13. The multipurpose console of claim 8 wherein the housing further includes a rechargeable battery source and an inverter to provide battery power to the console, the power contact further adapted to recharge the battery source.

14. The multipurpose console of claim 8 wherein the housing further includes a 110 volt power outlet adapted to receive a plug and provide power to an independent electronic device, the power contact further adapted to provide power to the outlet.

15. The multipurpose console of claim 8 wherein the housing further includes a first compartment, the first compartment having a thermoelectric device for heating or cooling the first compartment, and wherein the housing further includes an electronic device including at least one of a radio, DVD player, MP3 input, and navigational unit, the power source adapted to provide power to the thermoelectric device and the electronic device.

16. A multipurpose console for use in a vehicle, comprising:
a housing comprising:
at least one anchor point;
a latching mechanism, the latching mechanism being fixedly secured to a lower surface of the housing and configured to releasably engage a mounting mechanism of the vehicle so that the multipurpose console may be fastened thereto and removed therefrom; and
a transport device removably secured to the at least one anchor point to transport the removable console.

17. The multipurpose console of claim 16 wherein the housing further includes opposing ends and the at least one anchor point comprises two anchor points, each of the two anchor points associated with one end of the housing, the transport device further including opposing ends, each of the opposing ends of the transport device being removably secured to one of the two anchor points to transport the removable console.

18. The multipurpose console of claim 17 wherein the transport device is a shoulder strap.

19. The multipurpose console of claim 16 wherein the housing further includes a first compartment, the first compartment having a thermoelectric device for heating or cooling the first compartment, and wherein the housing further includes an electronic device including at least one of a radio, DVD player, MP3 input, and navigational unit.

20. The multipurpose console of claim 16 wherein the housing further includes a rechargeable battery source and an inverter to provide battery power to the console.
